(19) United States
(12) Patent Application Publication
(10) Pub. No.: US 2025/0129730 A1
(43) Pub. Date: Apr. 24, 2025

(54) OIL FILTER BASE ASSEMBLY

(71) Applicant: WENZHOU BONAI AUTO RADIATOR CO.,LTD, Wenzhou (CN)

(72) Inventors: Guang LI, Wenzhou (CN); Mingzheng TAO, Wenzhou (CN); Qi KE, Wenzhou (CN)

(73) Assignee: WENZHOU BONAI AUTO RADIATOR CO.,LTD, Wenzhou (CN)

(21) Appl. No.: 18/493,201

(22) Filed: Oct. 24, 2023

(51) Int. Cl. F01M 11/03; B01D 35/00; B01D 35/30

(52) U.S. Cl. CPC F01M 11/03; B01D 35/005; B01D 35/30; F01M 2011/033

(57) ABSTRACT

Disclosed is an oil filter base assembly, including an oil filter base, where the oil filter base has one side connected to a first cooler arranged and the other side connected to a second cooler arranged; With the arrangement of the first cooler and the second cooler on the oil filter base, a medium may pass through the two coolers and be cooled simultaneously by the two coolers, thereby improving the cooling effect of the oil filter base assembly. Therefore, the present invention is worthy of popularization and application.

### TECHNICAL FIELD

The present invention relates to the technical field of oil filters, and specifically to an oil filter base assembly.

### BACKGROUND

An oil filter is usually arranged at the bottom of an engine of a fuel vehicle. The oil filter may filter impurities such as dust, metal particles, carbon deposits, and soot particles in engine oil to protect the engine, and especially may be used to dissipate heat from a liquid medium entering the engine. However, existing oil filters have basically same radiator structures and only have single heat dissipation mechanisms. For example, in the prior art of CN114517720A, there is only one radiator mounted on one side of an oil filter base, and in the prior art of U.S. Pat. No. 11,635,005B2, there are similar issues.

### SUMMARY

An objective of the present invention is to provide an oil filter base assembly, to solve the problems raised in the above background.

To achieve the above objective, the present invention provides the following technical solution: an oil filter base assembly includes an oil filter base, where the oil filter base has one side connected to a first cooler arranged and the other side connected to a second cooler arranged; a first medium channel and a second medium channel are further arranged inside the oil filter base; opposite ends of the first medium channel and the second medium channel are both connected to interiors of the first cooler and the second cooler; and one end, away from the first cooler, of the first medium channel is connected to a medium inlet provided on the oil filter base, and one end, away from the first cooler, of the second medium channel is connected to an engine through a pipeline.

As a preferred technical solution of the present invention, the oil filter base is made of an aluminum alloy.

As a preferred technical solution of the present invention, the first medium channel and the second medium channel are arranged on the oil filter base in parallel.

As a preferred technical solution of the present invention, a process hole on an end surface of the oil filter base is of a sealed structure.

As a preferred technical solution of the present invention, a plug is provided in the process hole and is welded onto the process hole by means of a laser welding process to be inside an oil circuit.

As a preferred technical solution of the present invention, both the first cooler and the second cooler are made of the aluminum alloy.

With the above technical solution, the present invention has the beneficial effects as follows: with the arrangement of the first cooler and the second cooler on the oil filter base, a medium may pass through the two coolers and be cooled simultaneously by the two coolers, thereby improving the cooling effect of the oil filter base assembly, reducing the impact of heat on the oil filter base assembly, effectively lowering the risk of high-temperature failure of a vehicle during long-time running, and prolonging the service life of the oil filter base assembly.

### BRIEF DESCRIPTION OF DRAWINGS

FIG. 1 is a schematic diagram of one side of a main structure of the present invention;

FIG. 2 is a schematic diagram of the other side of a main structure of the present invention;

FIG. 3 is a schematic exploded view of a main structure of the present invention; and

FIG. 4 is a schematic diagram of a sectional structure of an oil filter base in the present invention.

In the drawings: 1. oil filter base; 2. first cooler; 3. second cooler; 4. first medium channel; 5. second medium channel; 6. medium inlet; and 7. process hole.

### DETAILED DESCRIPTION OF THE EMBODIMENTS

The embodiments of the present invention are described in detail below. The examples of the embodiments are shown in the accompanying drawings, in which the same or similar reference numbers represent the same or similar elements or elements with the same or similar functions throughout. The embodiments described below with reference to the accompanying drawings are exemplary and intended to explain the present invention, and should not be construed as a limitation to the present invention. In the description of the present invention, it should be understood that the orientations or positional relationships indicated by the terms “upper”, “lower”, “front side”, “upper surface”, etc. are based on the orientations or positional relationships shown in the accompanying drawings, merely for the convenience of describing the present invention and simplifying the description, rather than indicating or implying that the referred apparatus or element must have a particular orientation or be constructed and operated in a particular orientation, and therefore cannot be understood as limiting the present invention.

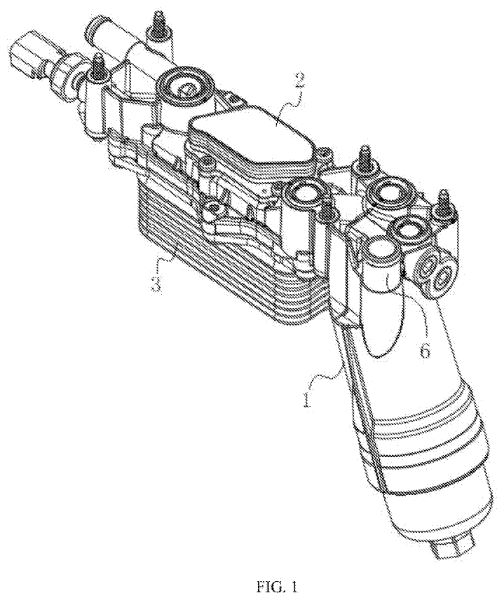

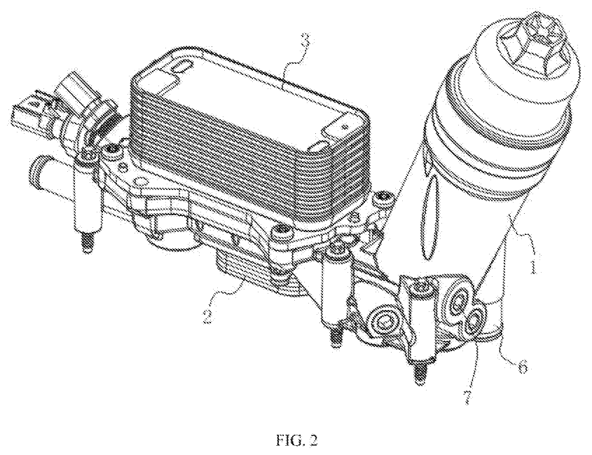

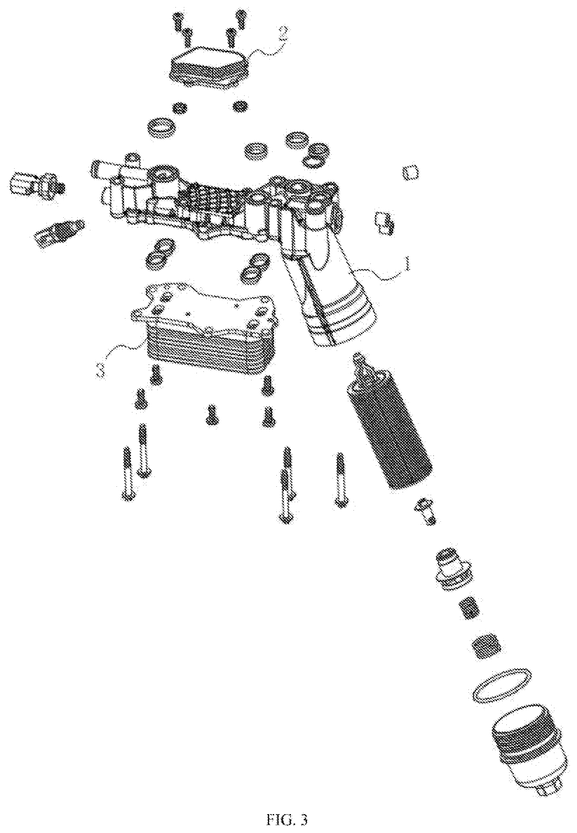

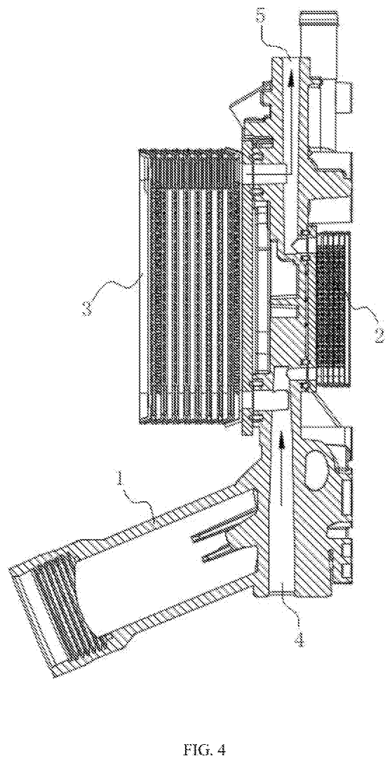

Referring to FIGS. 1 to 4, the present invention provides an embodiment as follows: an oil filter base assembly includes an oil filter base 1, where the oil filter base 1 has one side connected to a first cooler 2 arranged and the other side connected to a second cooler 3 arranged; a first medium channel 4 and a second medium channel 5 are further arranged inside the oil filter base 1; opposite ends of the first medium channel 4 and the second medium channel 5 are both connected to interiors of the first cooler 2 and the second cooler 3; and one end, away from the first cooler 2, of the first medium channel 4 is connected to a medium inlet 6 provided on the oil filter base 1, and one end, away from the first cooler 2, of the second medium channel 5 is connected to an engine through a pipeline.

In summary, because the two coolers are mounted on two side surfaces of the oil filter base 1, when passing through the first cooler 2 and the second cooler 3, a medium may be cooled simultaneously by using the two coolers, thereby improving the cooling effect of the oil filter base assembly. Specifically, the first cooler 2 is added, such that a small oil cooler structure is added to the oil filter base assembly, and a new dual-oil-cooler structure formed by combining small and large oil coolers is formed, thereby effectively reducing the impact of heat on the oil filter base assembly, lowering the risk of high-temperature failure of a vehicle during long-time running, and prolonging the service life of the oil filter base assembly.

Because the oil filter base assembly is mounted at a lower end of the engine, which belongs to a high-temperature working environment, market feedbacks show that the oil filter base assembly has the disadvantages of a short service cycle, many customer complaints, non-hydrolysis-resistant plastic parts, no resistance to high temperature, and poor thermal stability, resulting in customer complaints of early aging failure.

In view of this, in order to solve the problem of deformation of the oil filter base 1 made of a plastic due to an influence of high temperature, the oil filter base 1 is made of an aluminum alloy. Because the oil filter base 1 is made of the aluminum alloy, the problem of thermal deformation of the oil filter base 1 may be solved and the heat dissipation effect of the oil filter base may be enhanced.

On the basis of the above solution, the first medium channel 4 and the second medium channel 5 are arranged on the oil filter base 1 in parallel. Therefore, compared with a single medium channel arranged obliquely in an existing oil filter base assembly, machining is more convenient and flow of the medium is not affected.

Based on this, an oil circuit structure of the oil filter base assembly includes two parallel medium channels connected through the first cooler, such that cooling of engine oil may be accelerated and an effect of oil circuit connection is achieved.

In order to solve the problem of liquid leakage for a plug mounted on the oil filter base 1, a process hole 7 on an end surface of the oil filter base 1 is of a sealed structure. Specifically, the plug is mounted in the process hole 7 by pressing in a close-fit manner and then is welded in the process hole 7 by means of a laser welding process. Based on this, the problem of liquid leakage may be completely solved.

Further, both the first cooler 2 and the second cooler 3 are made of the aluminum alloy. Therefore, the heat dissipation capability of the oil filter base assembly may be enhanced while the structural strength of the two coolers is strengthened, where the first cooler 2 and the second cooler 3 have a same effect except for different external shapes and both are configured to cool the engine oil.

The working principle of the oil filter base assembly is roughly as follows: the engine oil enters the oil filter base assembly from an oil inlet port of the medium inlet 6, is filtered through a filter element, and then enters the second cooler 3 for cooling, or the engine oil may be cooled through an internal oil passage by the first cooler 2 and directly flow back to the engine; and the filtered and cooled engine oil flows back into the engine for lubrication from an oil outlet, i.e., the second medium channel 5.

The embodiments of the present invention are described in detail above with reference to the accompanying drawings, but the present invention is not limited to the described embodiments. Various changes, modifications, substitutions, and variations made to these embodiments by those skilled in the art without departing from the principle and spirit of the present invention still fall within the scope of protection of the present invention.

What is claimed is:

1. An oil filter base assembly, comprising an oil filter base (1), wherein the oil filter base (1) has one side connected to a first cooler (2) arranged and the other side connected to a second cooler (3) arranged;
a first medium channel (4) and a second medium channel (5) are further arranged inside the oil filter base (1);
opposite ends of the first medium channel (4) and the second medium channel (5) are both connected to interiors of the first cooler (2) and the second cooler (3); and
one end, away from the first cooler (2), of the first medium channel (4) is connected to a medium inlet (6) provided on the oil filter base (1), and one end, away from the first cooler (2), of the second medium channel (5) is connected to an engine through a pipeline.

2. The oil filter base assembly according to claim 1, wherein the oil filter base (1) is made of an aluminum alloy.

3. The oil filter base assembly according to claim 2, wherein the first medium channel (4) and the second medium channel (5) are arranged on the oil filter base (1) in parallel.

4. The oil filter base assembly according to claim 3, wherein a process hole (7) on an end surface of the oil filter base (1) is of a sealed structure,

5. The oil filter base assembly according to claim 4, wherein a plug is provided in the process hole (7) and is welded onto the process hole (7) by means of a laser welding process.

6. The oil filter base assembly according to claim 5, wherein both the first cooler (2) and the second cooler (3) are made of the aluminum alloy.
